(19) United States
(12) Patent Application Publication
(10) Pub. No.: US 2016/0221510 A1
(43) Pub. Date: Aug. 4, 2016

(54) Farm Implement with Retractable Ladder

(71) Applicant: UNVERFERTH MANUFACTURING COMPANY, INC., Kalida, OH (US)

(72) Inventor: Brian James PETERSEN, Ottawa, OH (US)

(73) Assignee: UNVERFERTH MANUFACTURING COMPANY, INC., Kalida, OH (US)

(21) Appl. No.: 14/711,235

(22) Filed: May 13, 2015

Related U.S. Application Data
(60) Provisional application No. 62/110,688, filed on Feb. 2, 2015.

(51) Int. Cl. B60R 3/02; E06C 5/44; B62D 63/08; B62D 33/02

(52) U.S. Cl. CPC B60R 3/02; B62D 33/02; E06C 5/44; B62D 63/08

(57) ABSTRACT

A farm implement includes a ladder for climbing in relation to a container. The ladder includes an upper ladder portion and a lower ladder portion. The upper end of the upper ladder portion is pivotably connected to the container via a first pivot defining a first horizontal pivot axis about which the upper ladder portion is pivotable between a retracted position against the container and an extended position angled away from the container, and a first end of the lower ladder portion is pivotably connected to the lower end of the upper ladder portion via a second pivot defining a second horizontal pivot axis about which the lower ladder portion is pivotable between a folded position extending upwardly along the upper ladder portion and an unfolded position extending downwardly from the upper ladder portion. A movable pivot link is pivotably connected to the lower end of the upper ladder portion via a third pivot defining a third horizontal pivot axis, and the upper ladder portion includes a pivoting step connected to the movable pivot link via the third pivot and connected to the upper ladder via a fourth pivot defining a fourth horizontal pivot axis about which the pivoting step is pivotable between retracted and extended positions.

### CROSS-REFERENCE TO RELATED APPLICATIONS

This application claims priority to U.S. Provisional Patent Application Ser. No. 62/110,688, filed on Feb. 2, 2015, the disclosure of which is incorporated herein by reference in its entirety.

### BACKGROUND OF THE INVENTION

1. Field of the Invention

The present invention relates to the field of farm implements and, more particularly, to a farm implement with a ladder that has retractable features that allow for additional comfort and safety over existing ladders.

2. Description of the Background Art

In the agricultural industry, wagons, grain carts, seed tenders, and bins may have one or more ladders attached to the outside of the implement. These ladders may be used by an operator to inspect portions of the implement that are not easily observed from the ground. For example, in a grain cart or seed tender with a bin for storing agricultural material, the ladder may be used to visually determine an amount of agricultural material in the bin. Current ladders may be fixed to the implement in a stationary manner, or they may include a fixed upper portion and a movable lower portion that can be extended downwardly from the fixed upper portion for easier operator access. In the latter case, the fixed upper portion of the ladder is typically vertical and is positioned close to the implement to maintain an acceptable profile for transport and storage. The movable lower portion can be retracted when not in use to prevent any interactions between the ladder and the rest of the implement and to provide ground clearance during transport.

Current ladders are useful but they have a number of disadvantages. These include restricted foot area and awkward positioning that makes it inconvenient for operators to inspect the implement. As such, there is a need for an improved ladder on farm implements.

### SUMMARY OF THE INVENTION

In accordance with a first aspect of the invention, a farm implement includes a ladder with movable upper and lower portions configured to assume an easily accessible and convenient position relative to the implement in an extended position and a compact profile in a retracted position. In an embodiment, the ladder includes an upper ladder portion and a lower extension ladder or portion, connected to the upper ladder. The apparatus includes a lower pivot link connecting the upper ladder to a farm implement. The apparatus may also include a latch connecting the lower ladder extension to the upper ladder. The release of the latch results in moving the lower ladder extension away from the upper ladder while simultaneously moving the upper ladder and the lower pivot link. In an embodiment, the lower pivot link is connected to the upper ladder portion via a pivoting step.

In accordance with second aspect of the invention, a method of operating a ladder on a farm implement includes releasing a latch associated with a ladder connected to the farm implement. The method further includes pulling a lower ladder extension or portion away from a lower end of an upper ladder portion. The method further includes that pulling of the lower ladder extension results in an upper portion of the ladder to move about a pivot and a lower pivot link to move about another pivot that causes the lower pivot link and the upper portion of the ladder to move away from the device. In an embodiment, pulling the lower ladder extension downwardly may also cause a pivoting step to assume a position in which it defines a rung of the upper ladder portion.

In accordance with a third aspect of the invention, a farm implement includes a container and a ladder for climbing in relation to the container. The ladder includes an upper ladder portion having upper and lower ends, the upper end of the upper ladder portion being pivotably connected to the container via a first pivot defining a first horizontal pivot axis about which the upper ladder portion is pivotable between a retracted position against the container and an extended position angled away from the container. The ladder also includes a lower ladder portion having first and second ends, the first end of the lower ladder portion being pivotably connected to the lower end of the upper ladder portion via a second pivot defining a second horizontal pivot axis about which the lower ladder portion is pivotable between a folded position extending upwardly along the upper ladder portion and an unfolded position extending downwardly from the upper ladder portion. The ladder also includes a movable pivot link having an outer end pivotably connected to the lower end of the upper ladder portion via a third pivot defining a third horizontal pivot axis. The upper ladder portion also includes a pivoting step connected to the movable pivot link via the third pivot and connected to the upper ladder via a fourth pivot defining a fourth horizontal pivot axis about which the pivoting step is pivotable between retracted and extended positions.

In an embodiment, the container includes a lower inclined wall extending inwardly and downwardly from an upper side wall. In an embodiment, the upper ladder portion bends inwardly at or below the junction between the upper side wall and lower inclined wall of the container to provide a narrower profile in the retracted position. In an embodiment, the farm implement may also include a frame. In an embodiment, the movable pivot link includes a pair of links extending in parallel from the frame to the upper ladder portion and the pair of links are connected by a cross member to improve lateral stability. In an embodiment, the movable pivot link extends upwardly from the frame to the pivoting step and the pivoting step in the retracted position is parallel to the upper ladder portion and in the extended position is perpendicular to the upper ladder portion. In an embodiment, the movable pivot link extends upwardly from the frame of the farm implement to the pivoting step at a pivot-link angle relative to horizontal. In an embodiment, the pivot-link angle is 60° in the retracted position and 30° in the extended position

In an embodiment, the lower ladder portion is pivotally connected to the pivoting step by a pair of short links that cause the lower ladder portion and the pivoting step to move together between the folded and the unfolded positions. In an embodiment, in the extended position the upper ladder portion extends outwardly and downwardly at an angle relative to vertical and the lower ladder portion extends from the upper ladder portion at the same angle, and in the retracted position the upper and lower ladder portions are adjacent to or inwardly spaced from an outer dimension of the farm implement. In an embodiment, the upper end of the upper ladder portion is pivotally connected to a bracket configured to be mounted on a surface of the container, the bracket including a mounting plate and a pair of vertical flanges extending perpendicularly outwardly from vertical edges of the mounting plate, and the upper ladder portion is connected to the flanges at the first pivot. In an embodiment, the first horizontal pivot axis is parallel to a side wall of the container. In an embodiment, the third and fourth horizontal axes of rotation are parallel to the first horizontal axis of rotation. In an embodiment, the second horizontal axis of rotation is parallel to and below the fourth horizontal axis of rotation.

In an embodiment, the upper ladder portion includes a pair of parallel upper uprights and a plurality of upper rungs extending transversely between the upper uprights at vertically spaced intervals to define steps. In an embodiment, the lower ladder portion includes a pair of parallel lower uprights and a plurality of lower rungs extending transversely between the lower uprights at vertically spaced intervals to define steps, and the lower uprights are pivotally connected to the upper uprights at the second pivot. In an embodiment, the pivoting step is deeper than the upper and lower rungs and is configured to be pivotable between a retracted position extending parallel to the upper uprights and an extended position extending inwardly at an angle from the upper uprights. In an embodiment, the upper uprights include a channel with a channel wall and the lower uprights are received within the channel and channel notches formed in the channel wall so that the upper rungs are received in the channel notches when the lower ladder portion is folded upwardly against the upper ladder portion in the retracted position.

In an embodiment, the farm implement also includes a latch mechanism for locking the latter in the retracted position. In an embodiment, the latch mechanism includes one or more spring-biased levers mounted on the lower ladder portion and having a latch notch for receiving a pin on the upper ladder portion when the ladder is in the retracted position. In an embodiment, the farm implement also has a dampener with a first end coupled to the lower ladder portion and a second end coupled to the upper ladder portion, the dampener configured to prevent the lower ladder portion from dropping in a rapid and uncontrolled manner. In an embodiment, the dampener is configured to provide a lifting force to assist in returning the lower ladder portion to the retracted position. In an embodiment, the dampener includes a gas spring.

### BRIEF DESCRIPTION OF DRAWINGS

FIG. 1 is a perspective view of a farm implement with a retractable ladder in a fully retracted position according to an embodiment of the present invention.

FIG. 2 is a front perspective view of a farm implement with a ladder in an extended position according to an embodiment of the present invention.

FIGS. 3A, 3B, and 3C are rear views of the farm implement shown in FIGS. 1 and 2, with the ladder in retracted, partially extended, and fully extended positions, respectively, according to an embodiment of the present invention.

FIG. 4A is a perspective view of a ladder for use with a farm implement in a retracted position according to an embodiment of the present invention.

FIG. 4B is a plan view of a ladder for use with a farm implement in a retracted position according to an embodiment of the present invention.

FIG. 4C is a section view of a ladder according to an embodiment of the present invention, taken through line A-A in FIG. 4B.

FIG. 5 is a perspective view of a ladder for use with a farm implement in a partially extended position according to an embodiment of the present invention.

FIGS. 6A and 6B are perspective views of a ladder for use with a farm implement in an extended position according to an embodiment of the present invention.

FIGS. 7A and 7B are front perspective views of a gravity wagon with a ladder in retracted and extended positions, respectively, according to an embodiment of the present invention.

FIGS. 7C, 7D, and 7E are left side views of the gravity wagon of FIGS. 7A and 7B showing the ladder in retracted, partially extended, and fully extended positions, respectively.

FIG. 8 is a rear view of a ladder in a partially retracted position according to an embodiment of the present invention.

FIG. 9 is an enlarged rear view of a ladder in a retracted position according to an embodiment of the present invention.

FIG. 10 is a rear view of a farm implement according to another embodiment of the present invention with a ladder in a retracted position.

### DETAILED DESCRIPTION

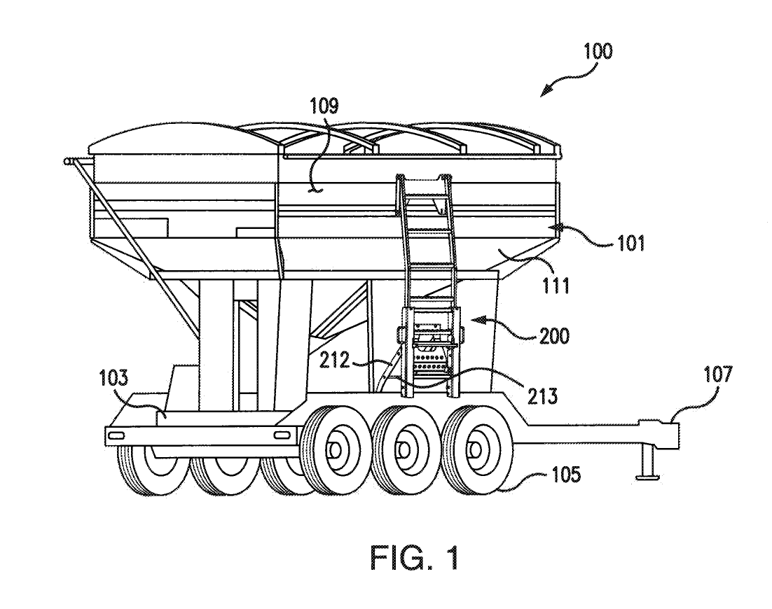

A ladder for a farm implement includes a plurality of retractable components that are linked together to fold in or out in such a manner that the movement of one retractable component can result in the movement of other retractable components, simultaneously. As such, the improved ladder can be folded in or out, i.e., retracted or extended, in one smooth seamless motion as further described in the following examples in FIGS. 1-7. Furthermore, the improved ladder may increase foot clearances between the ladder and the farm implement which, in turn, enhances safety and comfort for the person using the ladder.

FIGS. 1, 2, and 3A-3C show a farm implement 100 with a retractable ladder 200 according to an embodiment of the present invention. For purposes of illustration, farm implement 100 is shown as a seed tender; however, the ladder can be mounted on other types of farm implements, such as grain carts, gravity wagons, sprayers, and storage bins. Farm implement 100 may include a hopper or container 101 mounted on a frame 103 and supported by wheels 105 on left and right sides of the frame to provide mobility. A hitch 107 may be coupled to a front side of the frame 103 so that the implement can be towed behind a tractor or the like. While the implement is shown with three in-line wheels on each side of the frame, it will be appreciated that a fewer or greater number of wheels may be provided. Also, more than one wheel can be mounted on the same axle on each side of the frame. While the implement is shown with a set of wheels, it will be appreciated that tracks may be used if the implement is mobile and greater flotation is desired.

For purposes of illustration, ladder 200 is shown mounted vertically on a right side of farm implement 100 in longitudinal alignment with wheels 105; however, it will be appreciated that the ladder may be mounted forwardly or rearwardly of the wheels. It will also be appreciated that the ladder 200 may be mounted on the right or left side of the implement 100, along a front or rear side of the container, or at a corner of the container.

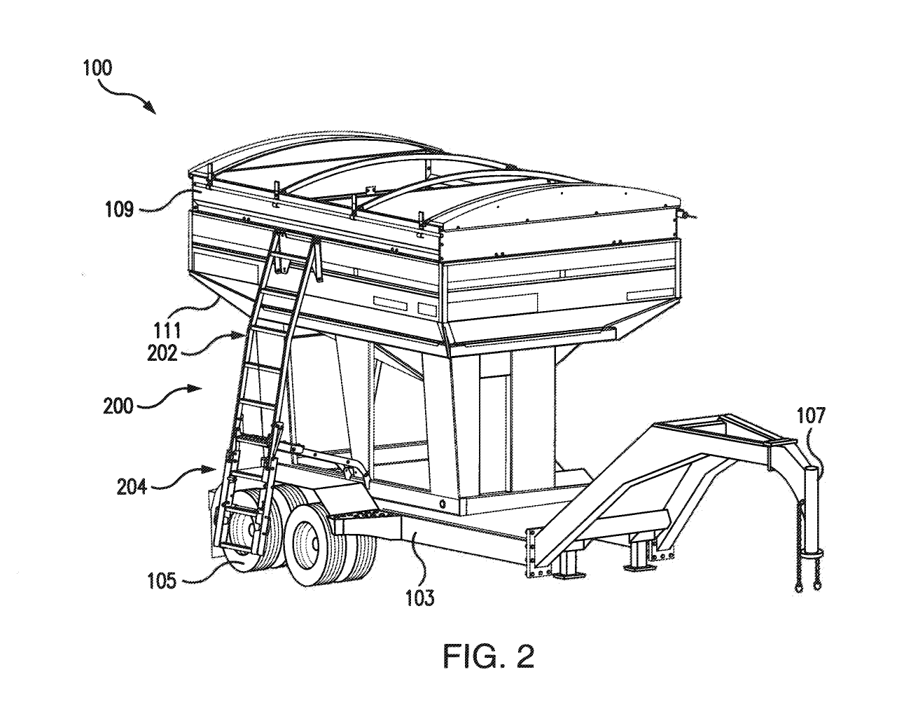

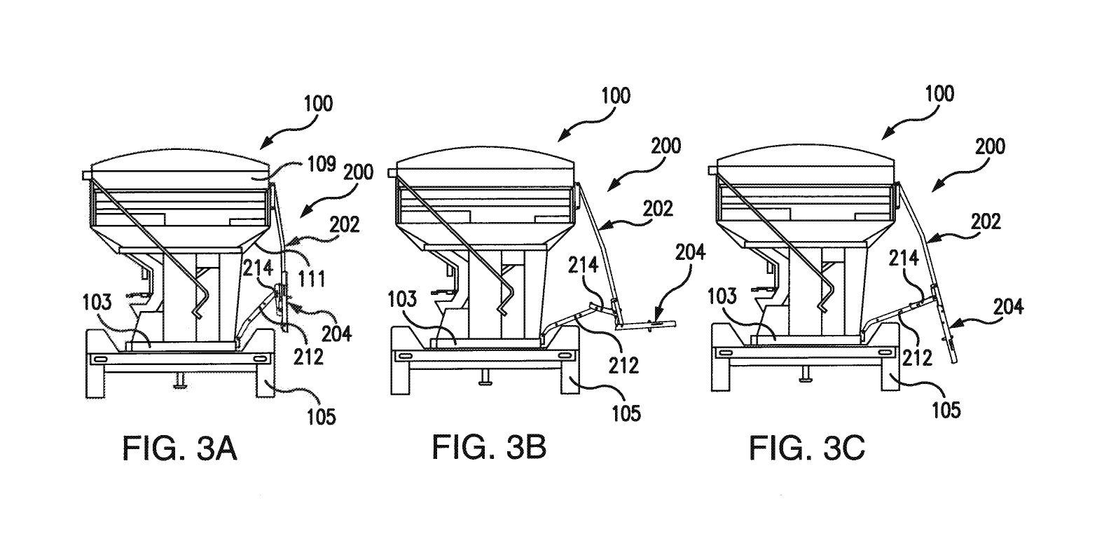

Ladder 200 includes an upper ladder portion 202 and a lower ladder portion or extension 204. Upper ladder portion 202 has an upper end pivotally connected to container 101 and a lower end pivotally connected to lower ladder portion 204. In an embodiment, upper ladder portion 202 may pivot between a retracted position close to the container 101 (e.g., as shown in FIGS. 1 and 3A) and an extended position extending downwardly and laterally outwardly from the container at an angle (e.g., as shown in FIGS. 2 and 3C). In an embodiment, container 101 includes a lower inclined wall 111 extending inwardly and downwardly from the upper side wall 109, and upper ladder portion 202 bends inwardly at or below the junction between the side and lower walls of the container to provide a narrower profile in the retracted position.

Referring still to FIGS. 1, 2, and 3A-3C, the lower end of upper ladder portion 202 preferably terminates above the wheels 105 so that it can pivot in and out with respect to the container 101 without interference from the wheels. The lower end of upper ladder portion 202 is shown connected to the frame 103 of implement 100 via moveable lower pivot links 212; however, it will be appreciated that the lower pivot links can connect the lower end of the upper ladder portion with other parts of the implement, such as the container. In an embodiment, a pair of lower pivot links 212 extend in parallel from the frame to the upper ladder portion 202. In an embodiment, the pivot links 212 are connected by cross members 213 to improve lateral stability at a lower end of the ladder.

In an embodiment, upper ladder portion 202 includes a pivoting step 214 defining a lower rung of the upper ladder portion, and pivot links 212 are connected to the upper ladder portion via the pivoting step. Pivoting step 214 may be pivotally coupled to upper ladder portion 202 at one end and to pivot links 212 at an opposite end so that it is movable between a retracted position (e.g., as shown in FIGS. 1 and 3A) parallel to the upper ladder portion and an extended position (e.g., as shown in FIGS. 2 and 3C) perpendicular to the upper ladder portion.

Lower ladder portion 204 has a first end pivotally connected to a lower end of upper ladder portion 202. A second end of lower ladder portion 204 is free to pivot about the lower end of the upper ladder portion 202 between a retracted position (e.g., as shown in FIGS. 1 and 3A) in which the lower ladder portion is folded upwardly against the upper ladder portion and an extended position (e.g., as shown in FIGS. 2 and 3C) in which the lower ladder portion extends downwardly from the upper ladder portion. In an embodiment, the lower ladder portion 204 is pivotally connected to the lower end of the upper ladder portion 202 below the pivoting step 214. In an embodiment, the lower ladder portion 204 is also pivotally coupled to the pivoting step 214 by a pair of short links 215 that cause the lower ladder portion and the pivoting step to move together between retracted and extended positions.

FIGS. 3A-3C show the farm implement 100 with the ladder 200 in three different positions: a retracted or transport position (FIG. 3A); a partially extended position (FIG. 3B); and a fully extended or operational position (FIG. 3C). In the retracted position, the upper ladder portion 202 may be disposed adjacent to the container 101 and the lower ladder portion 204 may be folded upwardly against the upper ladder portion 202 such that the second end of the lower ladder portion is above the first end of the lower ladder portion. In an embodiment, the lower pivot links 212 may extend upwardly from the frame 103 of the implement 100 to the pivoting step 214 at a first angle (e.g., 60°) relative to horizontal. In an embodiment, the entire ladder 200 may be adjacent to or inwardly spaced from an outer dimension of the implement 100 in the retracted position. For example, in the embodiment shown in FIG. 10, the ladder 200 is adjacent to or inwardly spaced from a vertical reference plane aligned with an outermost point on the right side of the implement 100 (e.g., an outermost surface of the wheels or side wall) such that the ladder does not significantly increase a width of the implement in the retracted position.

In the partially extended position shown in FIG. 3B, the lower ladder portion 204 is unfolded outwardly and downwardly, away from the upper ladder portion 206, such that the lower ladder portion extends laterally outward from the lower end of the upper ladder portion. At the same time, the lower end of the upper ladder portion 202 pivots laterally outwardly from the implement. In an embodiment, the lower pivot links 212 pivot downwardly away from the container as the lower ladder portion is unfolded. Furthermore, in an embodiment, the short links 215 cause the pivoting step 214 to begin pivoting inwardly and downwardly towards the container.

In the fully extended position, the upper ladder portion 202 extends outwardly and downwardly at an angle (e.g., 20°) relative to vertical and lower ladder portion 204 extends from upper ladder portion 202 at the same angle as the upper ladder portion. In an embodiment, the lower pivot links 212 extend upwardly from the frame 103 of the implement 100 to the pivoting step 214 at a second angle (e.g., 30°) relative to horizontal that is smaller than the first angle. In an embodiment, the second or lower end of the lower ladder portion 204 is positioned close enough to the ground in the extended position to allow a user to easily mount the ladder. In an embodiment, the length and angular orientation of the ladder in the extended position is such that the lower ladder portion 204 extends laterally outwardly beyond a reference plane aligned with the right side wall 109 of the container 101.

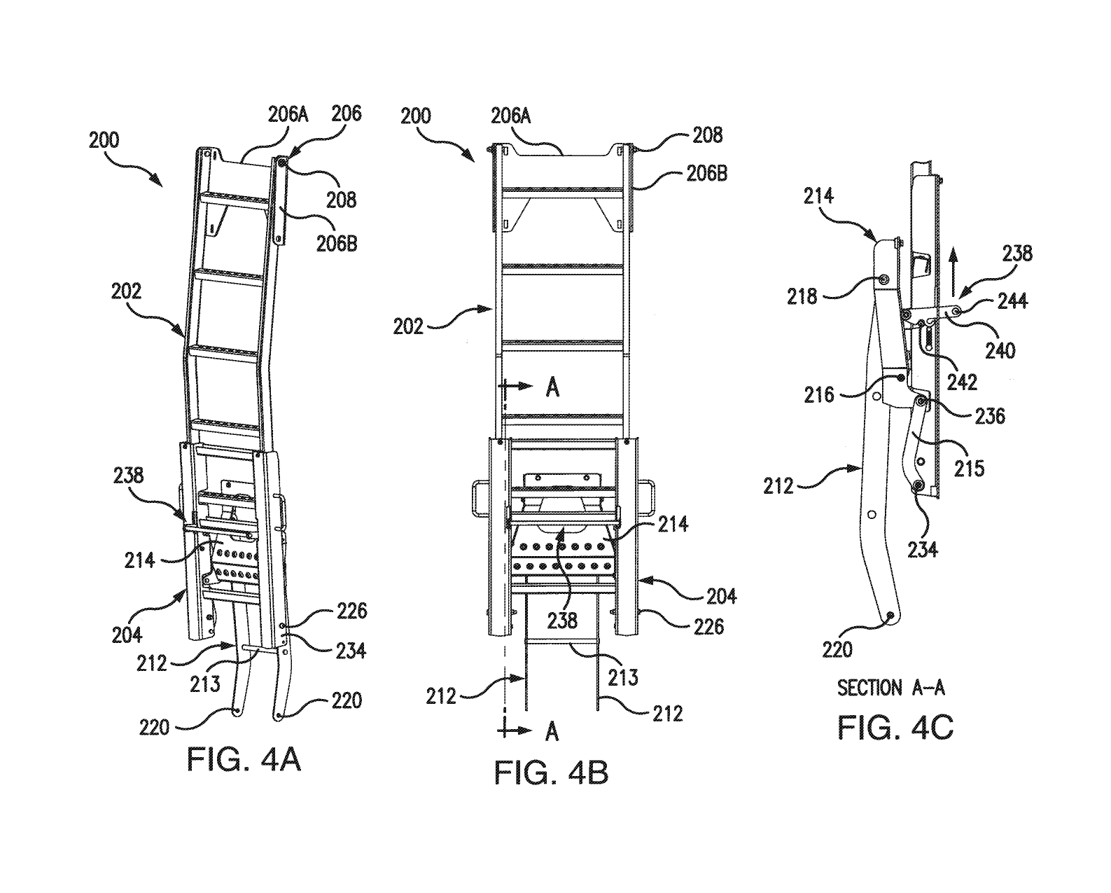

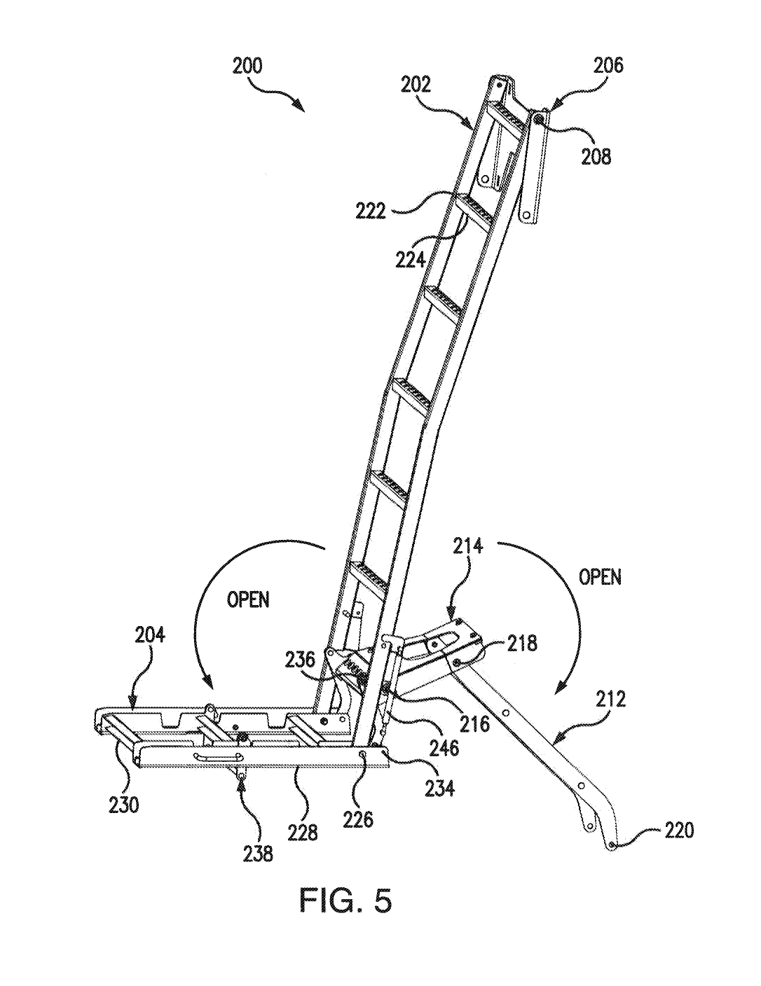

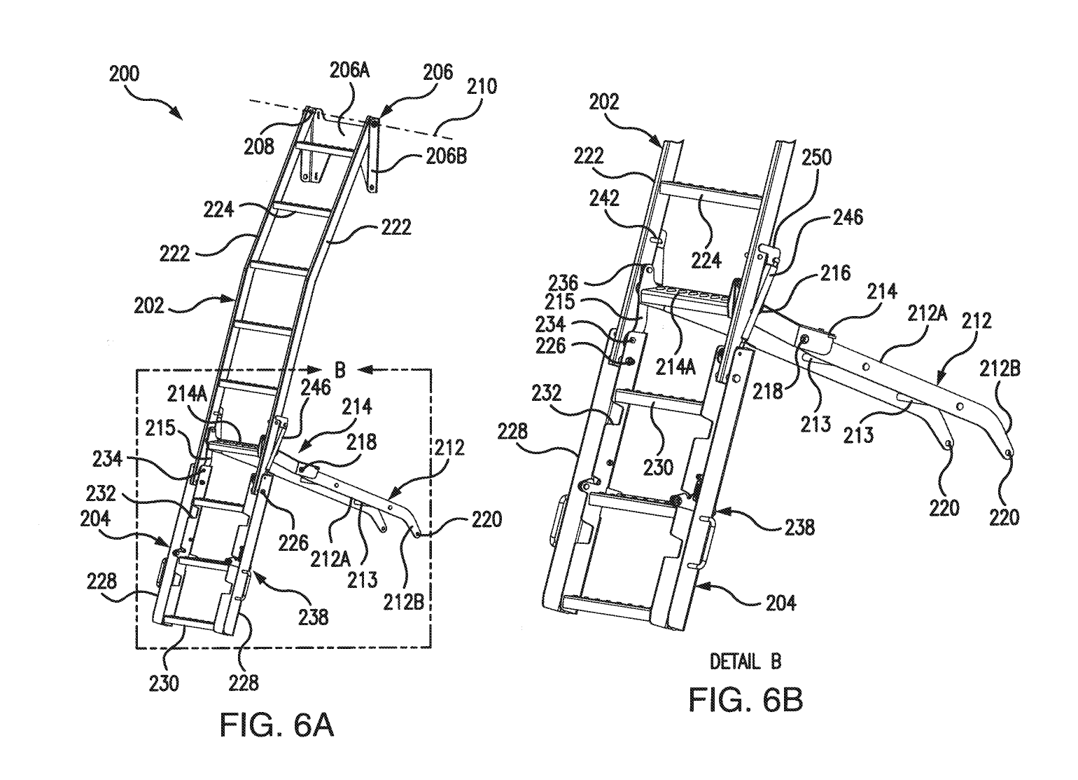

FIGS. 4A-4C, 5, and 6A-B are detailed views showing a ladder 200 for use with a farm implement 100 according to an embodiment of the present invention. FIGS. 4A-C show ladder 200 in a retracted position, FIG. 5 shows ladder 200 in a partially extended position, and FIGS. 6A-B show ladder 200 in a fully extended position. Ladder 200 includes an upper ladder portion 202 and a lower ladder portion 204. In an embodiment, upper ladder portion 202 includes a pair of uprights 222 and a plurality of rungs 224 extending transversely between the uprights at vertically spaced intervals to define steps.

In an embodiment, the upper end of upper ladder portion 202 is pivotally connected to a bracket 206 configured to be mounted on a container or other surface of the implement (e.g., the bracket 206 may be mounted on a right side wall 109 of the container 101 near a top of the container as shown in FIGS. 1-3). As best seen in FIGS. 4A and 4B, bracket 206 may include a mounting plate 206A and a pair of vertical flanges 206B extending perpendicularly outwardly from vertical edges of the mounting plate, and the upper ladder portion 202 may be connected to the flanges at upper pivots 208 that define an upper axis of rotation 210 about which the upper ladder portion may pivot. Referring again to FIGS. 1-3, the upper axis of rotation may be horizontal and parallel to the side wall 109 of the container 101.

Referring again to FIGS. 4A-4C, 5, and 6A-B, pivoting step 214 may be pivotally coupled to the uprights 222 at one end via step pivots 216 at a vertically spaced interval relative to an adjacent rung 224. Pivoting step 214 may be pivotally coupled to pivot links 212 at another end via outer link pivots 218. In an embodiment, the pivoting step 214 is deeper than the other rungs 224 and is configured to be pivotable between a retracted position extending parallel to the uprights 222 and an extended position extending inwardly at an angle (e.g., 90°) from the uprights (e.g., towards the container 101 as shown in FIGS. 1-3). In a preferred embodiment, a portion 214A of the pivoting step 214 adjacent to the uprights 222 is configured to define a step surface having the same or similar spacing and orientation as the other rungs 224 when the pivoting step is in the extended position (see, e.g., FIGS. 6A and 6B).

Referring still to FIGS. 4A-4C, 5, and 6A-B, each pivot link 212 may have a straight, elongate portion 212A extending from outer link pivots 218 at the ladder to a downwardly bent portion 212B that couples with the frame or some other part of the implement at inner link pivots 220. In an embodiment, outer and inner pivots 218 and 220 define inner and outer axes of rotation for the pivot links, respectively, that are parallel to the upper axis of rotation of the ladder.

In an embodiment, lower ladder portion 204 includes a pair of parallel uprights 228 (e.g., comprising c-shaped channel members) and a plurality of rungs 230 disposed transversely between the uprights at spaced intervals. The uprights 228 are pivotally connected to the uprights 222 at pivots 226 that define a lower axis of rotation about which the lower ladder portion may pivot. In an embodiment, the lower axis of rotation is parallel to and below the axis of rotation of the pivoting step. In an embodiment, uprights 222 are received within a channel defined by uprights 228, and notches 232 are formed in the channel walls so that rungs 224 in the upper ladder portion 202 are received in the notches 232 when the lower ladder portion 204 is folded upwardly against the upper ladder portion 202 in the retracted position (e.g., as shown in FIGS. 4A-C).

As best seen in FIG. 4C, short links 215 pivotally connect the lower ladder portion 204 to the pivoting step 214. In an embodiment, each short link 215 is pivotally coupled to the lower ladder portion 204 at a pivot 234 spaced from lower pivot 226, and is pivotally coupled to the pivoting step 214 at a pivot 236 spaced from pivot 216, so that movement of the lower ladder portion and the pivoting step is coupled via the short links.

Referring still to FIG. 4C, the ladder 200 may include a latch mechanism 238 for locking the ladder in the retracted position. Latch mechanism 238 may include one or more spring-biased levers 240 mounted on the lower ladder portion 204 and having a notch for receiving a pin 242 on the upper ladder portion 202 (or some other part of the ladder) when the ladder is in the retracted position. A lift bar 244 attached to a free end of the one or more levers 240 allows a user to lift the lever(s) away from the pin so that the lower ladder portion 204 may be released.

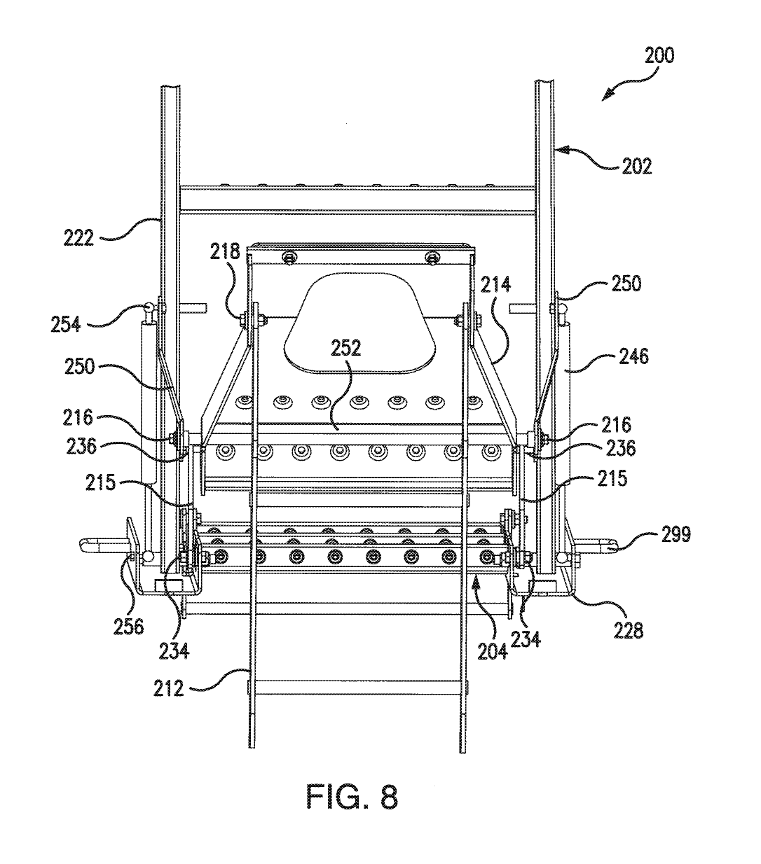

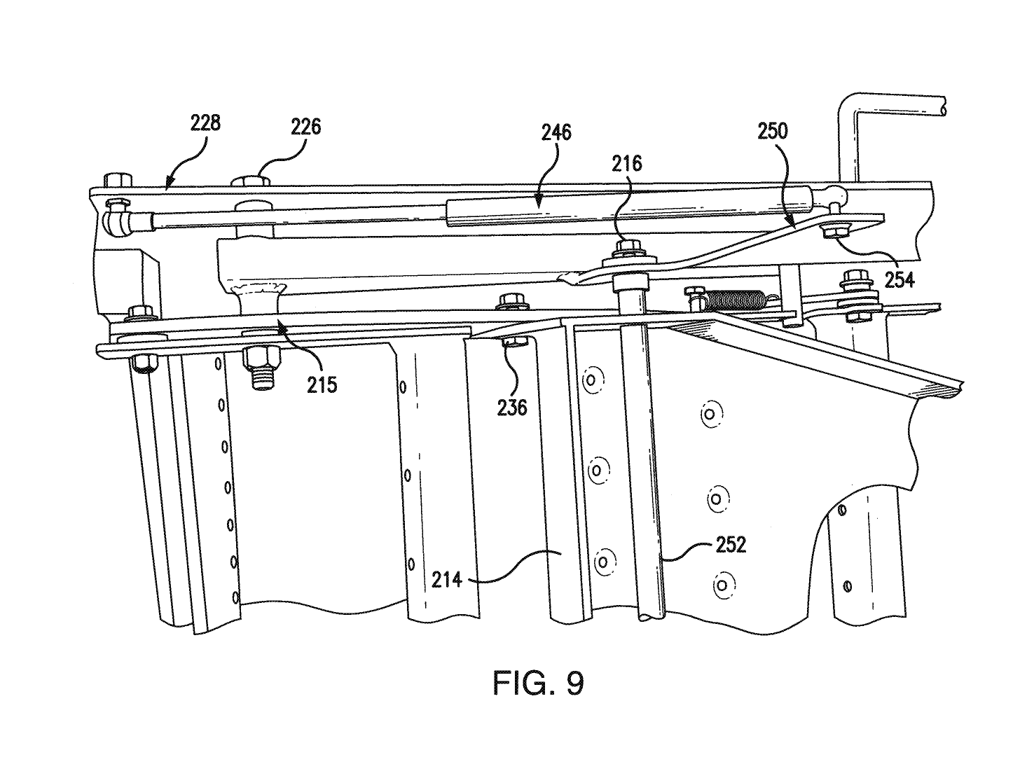

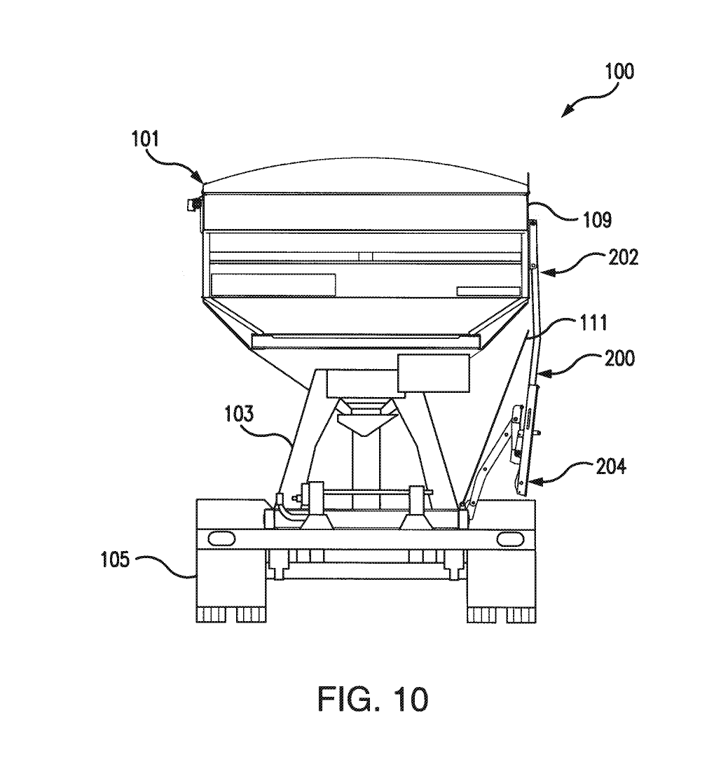

As best seen in FIGS. 5 and 6A-B, the ladder 200 may also include a dampener 246, such as a gas spring, to prevent the lower ladder portion from dropping in a rapid and uncontrolled manner. Dampener 246 may also be configured to provide a lifting force, e.g., via a spring, to assist in returning the lower ladder portion to a retracted position. Dampener 246 is further described with reference to FIGS. 8 and 9 below.

In use, to extend the lower ladder portion 204, the latch mechanism 238 is released, and the lower ladder portion begins to pivot about pivot 226. This moves the short link 215 so as to cause the pivoting step 214 to pivot about pivot 216. As this step 214 pivots down, it pushes through pivot 218 and the lower pivot link 212 to push the ladder 200 away from the farm implement (as the ladder pivots about pivot 208). Once the lower ladder portion 204 is completely lowered, pivot point 218 is over-centerline of points 216 and 220 to create an over-center latch to hold the lower portion of the ladder away from the farm implement. The dampener 246 helps prevent the lower ladder portion from dropping too quickly. The reverse operation folds the ladder 200 back up for transport; and, if the dampener includes a spring or other elements to provide a lifting force, raising the lower ladder portion upwardly from the extended position to the retracted position may be assisted by the dampener to reduce the amount of lifting force that a user needs to exert.

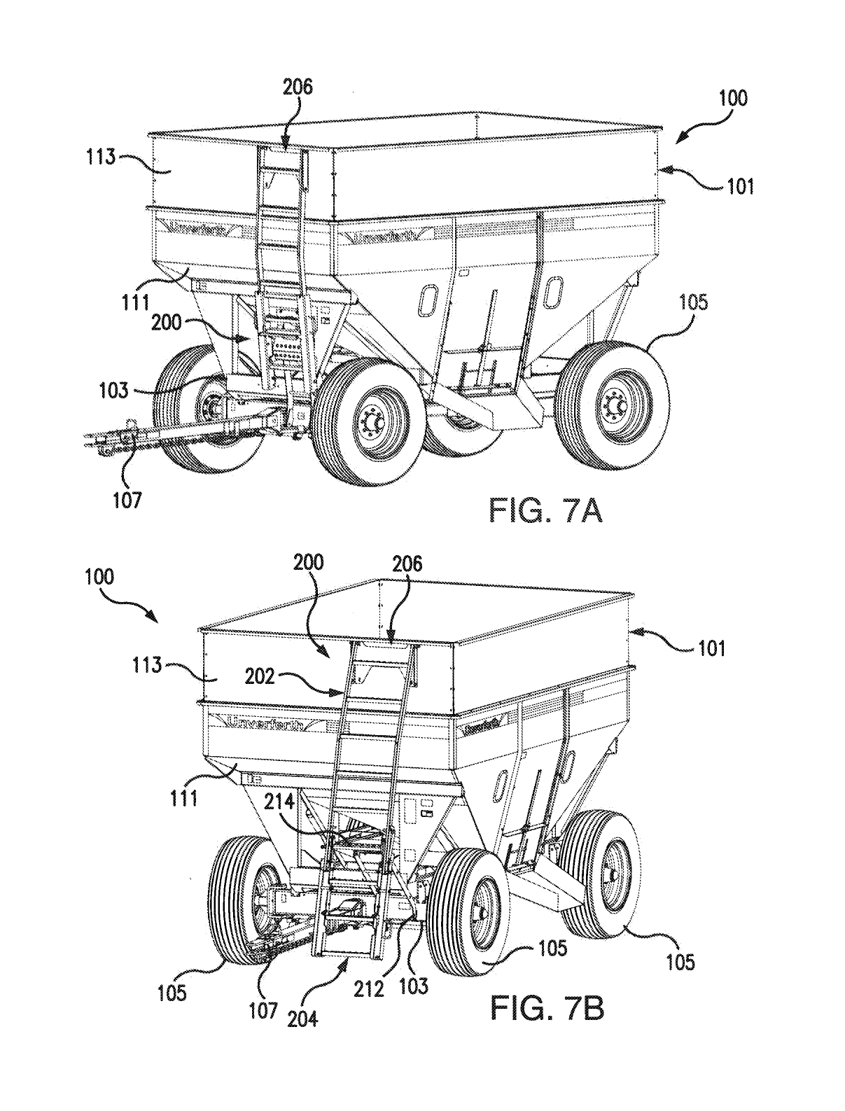

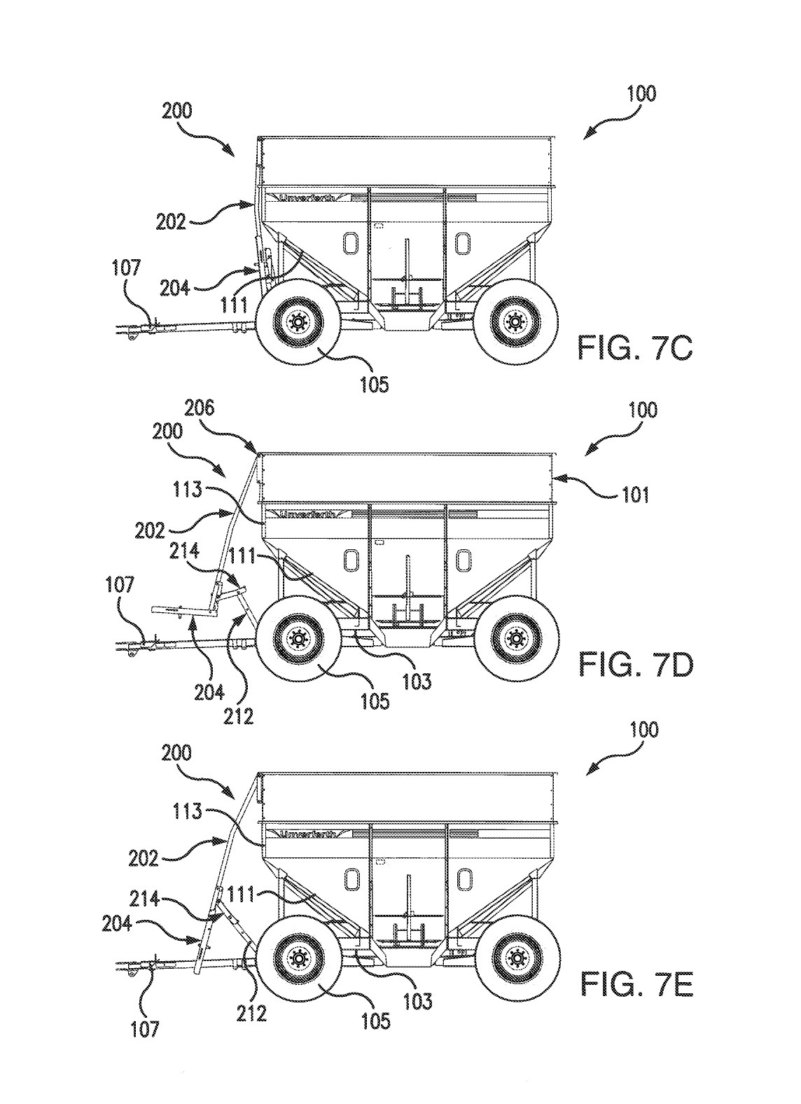

FIGS. 7A-7E show a ladder 200 of the type described above mounted on a front wall of a gravity wagon 100, which is another type of farm implement. Gravity wagon 100 includes a container 101 mounted on a frame 103 with wheels 105. A hitch 107 extends forwardly from the frame 103 for attachment to a tractor or the like. In this embodiment, ladder 200 is mounted on a front wall 113 of the container to one side of the hitch 107.

FIG. 8 shows a view of the backside of a ladder 200 according to an embodiment of the invention. Ladder 200 is in a partially retracted or partially extended position, e.g., as shown in FIG. 5. One end of dampener 246 is connected to lower ladder portion 204 and the other end of the dampener is connected to upper ladder portion 202 to prevent the lower ladder portion from dropping in a rapid and uncontrolled manner when it is unlatched from the upper ladder portion. Dampener 246 may include a spring or other elements, e.g., as a gas spring, to provide a lifting force to assist the user in returning the lower ladder portion 204 to a retracted position. In an embodiment, dampener 246 is connected to upright 228 of lower ladder portion 204 via a pivoting joint at 256 and is connected to upright 222 of upper ladder portion 202 via a pivoting joint at 254. In an embodiment, the pivoting joint is a ball joint. In an embodiment, a projection or arm 250 extends rearwardly from upright 222 and bends inwardly towards pivoting step 214, and dampener 246 is connected to the upper ladder 202 via the arm at 254. A free end of arm 250 preferably terminates near step 214, and a horizontal shaft 252 extends through the step and is pivotally connected at opposite ends to arms 250 to define a pivot axis 216 for the step. In a preferred embodiment, pivot axis 216 is disposed between lower link pivot axes 218 and short link pivot axes 236.

FIG. 9 is a close-up view of the dampener 246, upright 228, arm 250 and short link 215 when the ladder 200 is in the fully retracted position shown in FIGS. 4A-4C.

It will be appreciated that ladder 200 can be made out of any suitable material, such as a metal material, wood material, plastic-based material, fiberglass material, and/or a combination of different materials. Furthermore, the rungs of ladder 200 may have a pattern or grooves that allow for additional grip between a climber's shoe and the rung. While the term “rung” is used, it will be appreciated that such term is meant to encompass any type of step, bar, crossbar, or any other feature that can be used by a user to move up and down a ladder. In a preferred embodiment, one or more of the pivots may include a bushing, such as a nylon or metal bushing, to enhance smoothness of operation.

It will also be appreciated that the embodiments described herein are illustrative only, and that various modifications and changes can be made without departing from the invention. For example, the ladder can be located on other parts of the implement, such as the front, sides, or rear of the implement. Also, more than one ladder can be provided on a farm implement. The upper ladder portion can extend to the top of the implement or terminate below the top of the implement. Also, the movement of the upper and lower ladder portions may be decoupled so that they can be extended and retracted independently of one another. Moreover, while the ladder is particularly advantageous when used on farm implements, it may be used on other types of equipment. While a single mounting bracket is shown for pivotally connecting the upper end of the ladder to a container, it will be appreciated that more than one bracket can be used. It will also be appreciated that, while two pivot links are shown for connecting a lower end of the upper ladder portion to the implement, fewer or more than two pivot links can be used. Furthermore, while the lower end of the upper ladder portion is shown connecting to the frame of the implement via pivot links, it will be appreciated that the lower end can be connected to the container or some other portion of the implement via one or more pivot links. Also, while gas springs are disclosed for dampening downward movement of the lower ladder portion and providing a lifting force to assist in retracting the lower ladder portion, it will be appreciated that other types of dampening devices may be used. For example, various types of pneumatic, hydraulic, and electromechanical dampeners can be used. Preferably, such dampening devices include springs or other types of elements to provide a lifting force to assist in retracting the lower ladder portion. These and other modifications and changes are intended to be within the scope of the invention. CLAIMS

1. A farm implement for holding a farm product, the farm implement comprising:
a container; and
a ladder for climbing in relation to the container, the ladder including:
an upper ladder portion having upper and lower ends, the upper end of the upper ladder portion being pivotably connected to the container via a first pivot defining a first horizontal pivot axis about which the upper ladder portion is pivotable between a retracted position against the container and an extended position angled away from the container;
a lower ladder portion having first and second ends, the first end of the lower ladder portion being pivotably connected to the lower end of the upper ladder portion via a second pivot defining a second horizontal pivot axis about which the lower ladder portion is pivotable between a folded position extending upwardly along the upper ladder portion and an unfolded position extending downwardly from the upper ladder portion;
a movable pivot link having an outer end pivotably connected to the lower end of the upper ladder portion via a third pivot defining a third horizontal pivot axis; and
the upper ladder portion including a pivoting step connected to the movable pivot link via the third pivot and connected to the upper ladder via a fourth pivot defining a fourth horizontal pivot axis about which the pivoting step is pivotable between retracted and extended positions.

2. The farm implement of claim 1, wherein the container includes a lower inclined wall extending inwardly and downwardly from an upper side wall, and wherein the upper ladder portion bends inwardly at or below the junction between the upper side wall and lower inclined lower wall of the container to provide a narrower profile in the retracted position.

3. The farm implement of claim 1, further comprising a frame, wherein the movable pivot link includes a pair of links extending in parallel from the frame to the upper ladder portion, wherein the pair of links are connected by a cross member to improve lateral stability.

4. The farm implement of claim 1, further comprising a frame,
wherein the movable pivot link extends upwardly from the frame to the pivoting step, and
wherein the pivoting step in the retracted position is parallel to the upper ladder portion and in the extended position is perpendicular to the upper ladder portion.

5. The farm implement of claim 4,
wherein the movable pivot link extends upwardly from the frame to the pivoting step at a pivot-link angle relative to horizontal, and
wherein the pivot-link angle is 60° in the retracted position.

6. The farm implement of claim 4
wherein the movable pivot link extends upwardly from the frame to the pivoting step at a pivot-link angle relative to horizontal, and
wherein the pivot-link angle is 30° in the extended position.

7. The farm implement of claim 1, wherein the lower ladder portion is pivotally connected to the pivoting step by a pair of short links that cause the lower ladder portion and the pivoting step to move together between the folded and the unfolded positions.

8. The farm implement of claim 1,
wherein, in the extended position, the upper ladder portion extends outwardly and downwardly at an angle relative to vertical and the lower ladder portion extends from the upper ladder portion at the same angle, and
wherein, in the retracted position, the upper and lower ladder portions are adjacent to or inwardly spaced from an outer dimension of the farm implement.

9. The farm implement of claim 1,
wherein the upper ladder portion includes a pair of parallel upper uprights and a plurality of upper rungs extending transversely between the upper uprights at vertically spaced intervals to define steps, and
wherein the lower ladder portion includes a pair of parallel lower uprights and a plurality of lower rungs extending transversely between the lower uprights at vertically spaced intervals to define steps, wherein the lower uprights are pivotally connected to the upper uprights at the second pivot.

10. The farm implement of claim 1,
wherein the upper end of the upper ladder portion is pivotally connected to a bracket configured to be mounted on a surface of the container, the bracket including a mounting plate and a pair of vertical flanges extending perpendicularly outwardly from vertical edges of the mounting plate, and
wherein the upper ladder portion is connected to the flanges at the first pivot.

11. The farm implement of claim 10, wherein the first horizontal axis of rotation is parallel to a side wall of the container.

12. The farm implement of claim 9, wherein the pivoting step is deeper than the upper and lower rungs and is configured to be pivotable between a retracted position extending parallel to the upper uprights and an extended position extending inwardly at an angle from the upper uprights.

13. The farm implement of claim 1, wherein the third and fourth horizontal axes of rotation are parallel to the first horizontal axis of rotation.

14. The farm implement of claim 1, wherein the second horizontal axis of rotation is parallel to and below the fourth horizontal axis of rotation.

15. The farm implement of claim 9, wherein the upper uprights include a channel with a channel wall and wherein the lower uprights are received within the channel and channel notches formed in the channel wall so that the upper rungs are received in the channel notches when the lower ladder portion is folded upwardly against the upper ladder portion in the retracted position.

16. The farm implement of claim 1, further comprising a latch mechanism for locking the ladder in the retracted position, the latch mechanism including one or more spring-biased levers mounted on the lower ladder portion and having a latch notch for receiving a pin on the upper ladder portion when the ladder is in the retracted position.

17. The farm implement of claim 1, further comprising:
a dampener with a first end coupled to the lower ladder portion and a second end coupled to the upper ladder portion, the dampener configured to prevent the lower ladder portion from dropping in a rapid and uncontrolled manner,
wherein the dampener is configured to provide a lifting force to assist in returning the lower ladder portion to the retracted position.

18. The farm implement of claim 1, wherein the dampener includes a gas spring.
